(19) United States
(12) Patent Application Publication
(10) Pub. No.: US 2004/0267635 A1
(43) Pub. Date: Dec. 30, 2004

(54) Logistics quotation management system and method

(76) Inventors: Wei-Shing Yang, Tu-chen (TW); Wenbo Mao, Shenzhen (CN); Sheng-Chi Luo, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/879,419

(22) Filed: Jun. 28, 2004

(30) Foreign Application Priority Data
Jun. 27, 2003 (TW) 92117598

(51) Int. Cl. G06F 17/60

(52) U.S. Cl. 705/26

(57) ABSTRACT

A system for logistics quotation management includes a plurality of user computers (10), a web site (12), a server (13), a database (15) and a plurality of client computers (16). The server includes a basic information maintaining module (130), a client information maintaining module (131), a quotation retrieving module (132), an abnormity criterion setting module (133), an abnormality controlling module (134), and a sorting module (135). The quotation retrieving module is for retrieving quotations. The abnormality criterion setting module sets an abnormality criterion. The abnormality controlling module determines whether a client quotation is abnormal, and updates the quotation. The sorting module is for sorting updated quotations. The database stores all kinds of data used and generated in the above-described processes. A related method is also disclosed.

### BACKGROUND OF THE INVENTION

1. Field of the Invention

The present invention relates to logistics quotation management systems and methods, and particularly to a logistics quotation management system and method that can distinguish and control abnormal logistics quotations.

2. Background of the Invention

Efficient logistics management is vital for vast multinational manufacturing corporations. The controlling of logistics expenses is the most important component of cost controlling. Generally, most corporations concentrate on efficient methods of arranging logistics schedules, but pay relatively little attention to efficiently controlling logistics quotations. The general method employed is to compare several forwarders' quotations, negotiate with some of the forwarders, and select a desired forwarder according to price and previous good business relations. With the increasing development of logistics technology and the ongoing innovation of logistics methods, logistics is nowadays playing a more and more important role in the supply chain. Interaction between suppliers and clients can be more comprehensive than previously, and logistics quotations can be highly impacted by other partners in the supply chain. Accordingly, modern logistics management should provide accurate forecasting and convenient manageability.

Computer-aided logistics management, scheduling and online quotation systems are disclosed in a number of patents. Some of these systems relate to selection of logistics means and quotation methods. However, most of these systems do not provide the function of setting an abnormality criterion for quotations and controlling abnormal quotations.

U.S. Pat. No. 20020116328 published on Aug. 22, 2002 and entitled “Automotive finance portal” discloses a method of processing an automotive finance transaction. The method includes the steps of: inputting business rules and rates for financial institutions; entering criteria of a chosen vehicle; selecting a financial institution; generating a comparative quote scheme for the chosen vehicle; and selecting a set of terms from the comparative quote scheme.

The above-described automotive finance portal method concentrates on the suitability of logistics selection and selection of financing. However, the method does not provide the function of setting an abnormality criterion and controlling abnormal quotations.

### SUMMARY OF THE INVENTION

Accordingly, a main objective of the present invention is to provide a logistics quotation management system and method which can set an abnormality criterion to determine whether a forwarder's quotation is an abnormal quotation.

Another objective of the present invention is to provide a logistics quotation management system and method which collects and saves reasons for abnormal quotations, for forecasting of future quotation trends.

A further objective of the present invention is to provide a logistics quotation management system and method which can automatically sort updated quotations according to terms set by users and thereby facilitate decision making by logistics controllers.

To accomplish the above objectives, a logistics quotation management system in accordance with a preferred embodiment of the present invention includes a plurality of user computers, a server, a web site, a database and a plurality of client computers. The user computers are connected to the web site through an electronic network. Each user computer provides an interactive user interface for users to log in the web site and maintain basic information. The web site is an operational forum for clients' online quotations. The server includes: a basic information maintaining module for maintaining quotation basic information; a client information maintaining module for maintaining client information; a quotation retrieving module for retrieving quotations; an abnormity criterion setting module for setting an abnormality criterion; an abnormity controlling module for determining whether a client's quotation is abnormal and updating the quotation; and a sorting module for sorting the updated quotations. The database stores all kinds of data used and generated in the above-described processes. Each client computer provides an interactive user interface for clients to log in the web site and quote online.

Further, the present invention provides a logistics quotation management method comprising the steps of: (a) maintaining quotation basic information and client information; (b) retrieving clients' quotations; (c) setting an abnormality criterion and calculating an abnormality value; (d) comparing each client's quotation with the abnormality value to determine whether the client's quotation is abnormal; if abnormal, sending an alarm message, requesting inputting of reasons for the abnormality, and updating the quotation; if not abnormal, directly updating the quotation; and (e) sorting the updated quotations.

Other objects, advantages and novel features of the present invention will be drawn from the following detailed description with reference to the attached drawings, in which:

### BRIEF DESCRIPTION OF THE DRAWINGS

FIG. 1 is a schematic diagram of hardware infrastructure of a logistics quotation management system in accordance with the preferred embodiment of the present invention;

FIG. 2 is a schematic diagram of main function units of a server of the logistics quotation management system of FIG. 1; and

FIG. 3 is a flowchart of a preferred method for implementing the logistics quotation management system of the present invention.

### DETAILED DESCRIPTION OF THE INVENTION

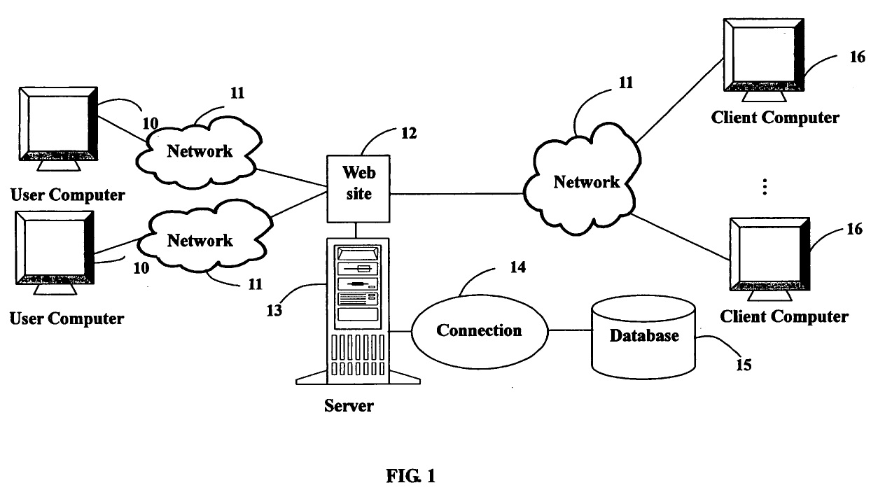

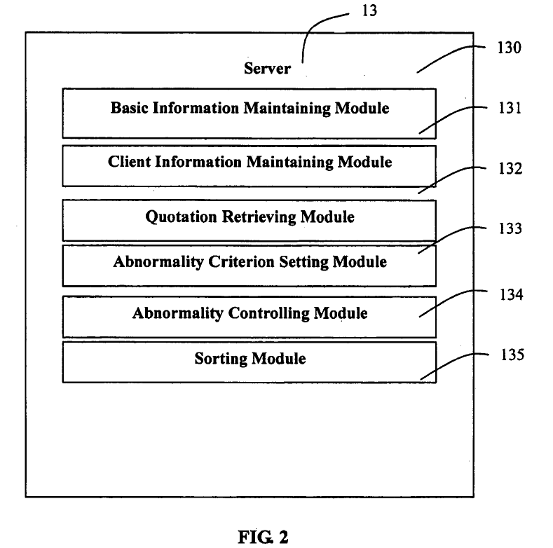

FIG. 1 of the drawings is a schematic diagram of hardware infrastructure of a logistics quotation management system (“the system”) in accordance with the preferred embodiment of the present invention. The system comprises a plurality of user computers 10, a web site 12, a server 13, a database 15, and a plurality of client computers 16. The user computers 10 are connected to the web site 12 through an electronic communications network 11. The network 11 may be any suitable communication architecture required by the system, such as a local area network or a wide area network. Each user computer 10 provides an interactive user interface for users to log in the web site 12 and maintain basic information. The users typically are logistics controllers. The web site 12 is an operational forum for clients' online quotations. The clients typically are forwarders. The server 13 is connected to the database 15 through a connection 14. The connection 14 is a database connectivity such as Open Database Connectivity (ODBC) or Java Database Connectivity (JDBC). The server 13 comprises a plurality of function units (described in detail below in relation to FIG. 2). The server 13 can retrieve quotations through the web site 12, set an abnormality criterion, calculate an abnormality value, control abnormal quotations, and sort quotations. The quotations, abnormality criterion and abnormality value are explained in more detail below. The database 15 stores all kinds of data used and generated in the above-described processes. Each client computer 16 provides an interactive user interface for clients to log in the web site 12 and quota online. The client computers 16 are connected to the web site 12 through the network 11.

FIG. 2 is a schematic diagram of main function units of the server 13. The server 13 comprises a basic information maintaining module 130, a client information maintaining module 131, a quotation retrieving module 132, an abnormity criterion setting module 133, an abnormity controlling module 134, and a sorting module 135.

The basic information maintaining module 130 maintains basic information needed in clients' quotations, including by way of adding, modifying, searching and deleting basic information. The basic information may include product name, category, material number, quantity, volume, net weight, gross weight, detailed description, port of loading, port of discharge, final destination, shipping date, destination date, forwarder, consignee, price clause, delivery mode and so on. Kinds of delivery modes mainly include ocean shipping, airlifting, land carriage and through transport. Kinds of price clauses customarily include price structures, price data, types of currency, etc. The basic information is stored in the database 15.

The client information maintaining module 131 maintains client information. The client information is stored in the database 15, and mainly includes names, addresses, accounts, contact means, main businesses, historical quotation details, etc.

The quotation retrieving module 132 is for retrieving clients' quotations through the web site 12. Columns of quotations are set in accordance with the basic information maintaining module 130.

The abnormity criterion setting module 133 is used for setting an abnormality criterion. The abnormality criterion may be a value, a rate or a range of values, such that when a quotation exceeds the value, rate or range of values, the system executes an abnormality operating procedure. For example, the abnormality criterion may be set to be a certain floating rate around an average quotation of the last three months. If a client's quotation exceeds the rate, the quotation is treated as an abnormal quotation. That is, the abnormity criterion setting module 133 retrieves historical quotation details of the client from the database 15, calculates the client's average quotation over the last three months, sets a permitted floating rate, and calculates an abnormality value according to the average quotation and the rate. The abnormality criterion, the average quotation, the rate and the abnormality value are stored in the database 15.

The abnormity controlling module 134 is to determine whether a client's quotation retrieved by the quotation retrieving module 132 is an abnormal quotation, and subsequently update the quotation. That is, the abnormity controlling module 134 compares the client's quotation with the average calculated by the abnormity criterion setting module 133. If the difference exceeds the abnormality value, the abnormity controlling module 134 sends an alarm message and requests inputting of reasons for the abnormality. After receiving the reasons, the abnormity controlling module 134 updates the quotation. If the difference does not exceed the abnormality value, the abnormity controlling module 134 directly updates the quotation. The reasons for the abnormality and the updated quotation are stored in the database 15.

The sorting module 135 is for sorting the updated quotations of different clients according to terms set by users. Customarily, a sorting sequence is from the lowest quotation to the highest quotation. The terms set by users may be delivery mode, destination, forwarder, product name, quantity, etc. Users can select one or more desired terms.

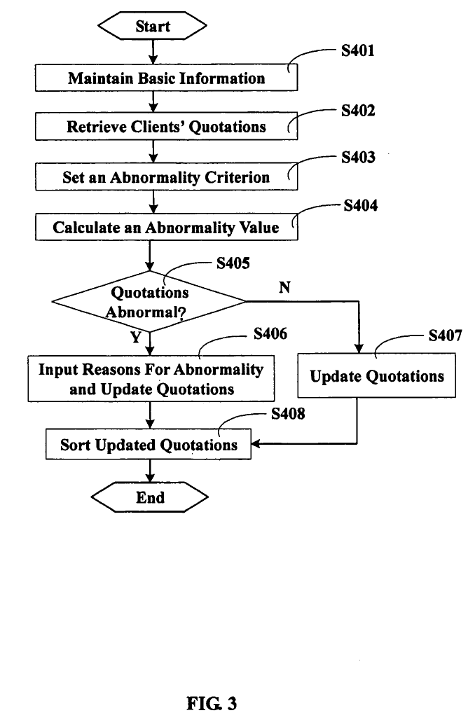

FIG. 3 is a flowchart of a preferred method for implementing the system of the present invention. In step S401, the basic information maintaining module 130 and client information maintaining module 131 maintain the basic information and the client information. In step S402, the quotation retrieving module 132 retrieves clients' quotations through the web site 12. In step S403, the abnormity criterion setting module 133 sets an abnormality criterion. In step S404, the abnormity criterion setting module 133 calculates an abnormality value. In step S405, the abnormity controlling module 134 determines whether a client's quotation is an abnormal quotation. That is, the abnormity controlling module 134 compares each client's quotation with the average calculated by the abnormity criterion setting module 133. If the difference exceeds the abnormality value, in step S406, the abnormity controlling module 134 sends an alarm message and requests inputting of reasons for the abnormality. After that, the abnormity controlling module 134 updates the quotation. If the difference does not exceed the abnormality value, in step S407, the system directly updates the quotation. Finally, in step S408, the sorting module 135 sorts the updated quotations of different clients according to terms set by users. The generated sequence is displayed to users through a user interface, and can be saved or printed.

Although the present invention has been specifically described on the basis of a preferred embodiment and a preferred method, the invention is not to be construed as being limited thereto. Various changes or modifications may be made to the embodiment and method without departing from the scope and spirit of the invention.

What is claimed is:

1. A logistics quotation management system for maintaining logistics quotations, comprising:
a plurality of user computers, each of the user computers providing a user interface for inputting and displaying data;
a database for storing information generated in processing quotations;
a server for determining abnormal quotations and sorting quotations, comprising:
a quotation retrieving module for retrieving quotations;
an abnormity criterion setting module for setting an abnormality criterion, in order to determine whether a client's quotation is abnormal;
an abnormity controlling module for determining whether the client's quotation is abnormal according to the abnormality criterion, and for updating the quotation; and
a sorting module for sorting updated quotations of different clients according to terms set by one or more users; and
a plurality of client computers, each of the client computers providing a user interface for submitting quotations.

2. The logistics quotation management system according to claim 1, further comprising a web site for providing an operational forum for clients' online quotations.

3. The logistics quotation management system according to claim 1, wherein the server further comprises a basic information maintaining module for maintaining basic information needed in quotations.

4. The logistics quotation management system according to claim 1, wherein the server further comprises a client information maintaining module for maintaining client information.

5. The logistics quotation management system according to claim 1, wherein the terms set by users include any one or more of delivery mode, destination, client, production name, and quantity.

6. The logistics quotation management system according to claim 1, wherein the abnormality criterion comprises any one or any combination of a value, a rate and a range of values.

7. A logistics quotation management method comprising the steps of:
retrieving clients' quotations;
setting an abnormality criterion;
determining whether each of clients' quotations is abnormal;
carrying out an abnormality procedure if a client's quotation is abnormal;
updating the quotations; and
sorting the updated quotations.

8. The method according to claim 7, further comprising the step of maintaining quotation basic information and client information.

9. The method according to claim 7, wherein the abnormality procedure includes sending an alarm message, and requesting inputting of reasons for the abnormality.
